(19) United States
(12) Patent Application Publication
(10) Pub. No.: US 2026/0349309 A1
(43) Pub. Date: Nov. 5, 2026

(54) ELECTRO-OPTIC DISPLAYS AND METHODS FOR PREPARING THE SAME

(71) Applicant: E Ink Corporation, Billerica, MA (US)

(72) Inventor: Eva Chen ALANIZ, Wrentham, MA (US)

(21) Appl. No.: 19/665,841

(22) Filed: May 1, 2026

Related U.S. Application Data
(60) Provisional application No. 63/798,185, filed on May 1, 2025.

(51) Int. Cl. G02F 1/167; G02F 1/1675; G02F 1/1676

(52) U.S. Cl. CPC G02F 1/167; G02F 1/1676; G02F 2001/1678

(57) ABSTRACT

Electro-optic displays, such as electrophoretic displays, and the methods of preparing the same are disclosed herein. Desirable electric optical performances, such as reduced levels of image retention (e.g., image sticking, “ghost” images) can be achieved with a preferred range of dopants in the binder that holds together a layer of electrophoretic medium.

### CROSS REFERENCE TO RELATED APPLICATIONS

This application claims the benefit of priority of U.S. Provisional Patent Application Ser. No. 63/798,185, filed May 1, 2025, the content of which is incorporated by reference in its entirety.

### BACKGROUND OF THE INVENTION

This invention relates to novel formulations for use in the fabrication of electro-optic devices, which provide improved electric optical properties.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Subsequently, attempts were made to enclose the suspension in microcapsules. U.S. Pat. Nos. 5,961,804 and 5,930,026 describe microencapsulated electrophoretic displays. The reference display has a substantially two dimensional arrangement of microcapsules each having therein an electrophoretic composition of a dielectric fluid and a suspension of charged pigment particles that visually contrast with the dielectric solvent. The microcapsules can be formed by interfacial polymerization, in-situ polymerization or other known methods such as physical processes, in-liquid curing or simple/complex coacervation. The microcapsules, after their formation, may be injected into a cell housing two spaced-apart electrodes, or “printed” into or coated on a transparent conductor film. The microcapsules may also be immobilized within a transparent matrix or binder that is itself sandwiched between the two electrodes.

The walls surrounding the discrete microcapsules in an encapsulated electrophoretic medium could be replaced by a continuous phase, thus producing a so-called polymer-dispersed electrophoretic display, in which the electrophoretic medium layer comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

Problems known to occur in electrophoretic displays include undesirable image retention between updates, e.g., “ghost images” or “image sticking”, especially after storage at elevated temperatures. While ghost images and image sticking could be reduced or eliminated by regular refreshes of electrophoretic displays, this solution is deemed undesirable by customers. Thus, there remains a need for alternative designs of electrophoretic displays that reduces or eliminates undesirable image retention without causing inconvenience to the customers.

### BRIEF SUMMARY OF THE INVENTION

One aspect of the present disclosure provides an electrophoretic display comprising: a light-transmissive top electrode; an electrophoretic medium layer comprising a continuous phase and a discontinuous phase; and a backplane electrode, wherein the discontinuous phase comprises a plurality of capsules encapsulating an electrophoretic medium and the continuous phase surrounds the discontinuous phase and comprises a binder, a surfactant, a viscosity modifier, a solvent, and a dopant; wherein the dry mass weight ratio of capsule to dopant is at least 2000:1; and wherein the electrophoretic display has a difference in white state (WS) L* of less than 2 L* after 2 resets for a white region and a black region of a test module after being exposed to 85 °C and 22% relative humidity for 7 days.

In some embodiments, the electrophoretic display has a difference in WS L* of less than 1.5 L* after 2 resets for the white region and the black region of the test module after being exposed to 85 °C and 22% relative humidity for 7 days.

In some embodiments, the dopant comprises an imidazolium cation and/or an anion containing at least three fluorine atoms. In some embodiments, the dopant comprises 1-butyl-3-methylimidazolium hexafluorophosphate. In some embodiments, the dry mass weight ratio of capsule to dopant is between 2000:1 to 5000:1. In some embodiments, the dry mass weight ratio of capsule to dopant is between 2000:1 to 3000:1. In some embodiments, the electrophoretic medium comprises two different kinds of charged pigment particles dispersed in a hydrocarbon solvent. In some embodiments, the two kinds of pigment particles are black pigment particles and white pigment particles.

In some embodiments, the electrophoretic display further comprises at least one layer of adhesive. In some embodiments, the electrophoretic display comprises a layer of adhesive between the electrophoretic medium layer and the top electrode. In some embodiments, the electrophoretic display comprises a layer of adhesive between the electrophoretic medium layer and the backplane electrode. In some embodiments, the electrophoretic display further comprises a color filter layer.

Another aspect of the present disclosure provides a method for preparing an electrophoretic display comprising: forming an electrophoretic medium layer comprising a continuous phase and a discontinuous phase; contacting a first layer of adhesive with the electrophoretic medium layer; contacting a second layer of adhesive with the opposed side of the electrophoretic medium layer from the previously coated layer of adhesive; and contacting one of the adhesive layers with a light-transmissive top electrode and the other adhesive layer with a backplane electrode; wherein the discontinuous phase comprises a plurality of capsules and the continuous phase surrounds the discontinuous phase and comprises a binder, a surfactant, a viscosity modifier, a solvent, and a dopant; and wherein the dry mass weight ratio of capsule to dopant is at least 2000:1.

In some embodiments, the dopant comprises an imidazolium cation and/or an anion containing at least three fluorine atoms. In some embodiments, the dopant comprises 1-butyl-3-methylimidazolium hexafluorophosphate. In some embodiments, the dry mass weight ratio of capsule to dopant is between 2000:1 to 5000:1. In some embodiments, the dry mass weight ratio of capsule to dopant is between 2000:1 to 3000:1. In some embodiments, the electrophoretic medium comprises two different kinds of charged pigment particles dispersed in a hydrocarbon solvent. In some embodiments, the two kinds of pigment particles are black pigment particles and white pigment particles. In some embodiments, the method further comprises applying a layer of color filter on the layer of electrophoretic medium.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A shows a representative cross-section of an electrophoretic display, e.g., including an electrophoretic layer of oppositely charged black and white particles, coupled to a color filter array (CFA) disposed between the electrophoretic layer and the viewer.

FIG. 1B shows an exemplary schematic cross-section through a front plane laminate (FPL).

FIG. 2A illustrates an exemplary RBGW color filter array pattern that can be used with a CFA-enabled color electrophoretic display. The dashed line defines a “pixel” for the purposes of defining a pixel in an image. Each pixel of the RGBW CFA includes an independently controllable red, green, and blue partially-transmissive filter portion, known as a “subpixel”; a clear (a.k.a. white) subpixel helps to improve white and light colors in an image. Below each subpixel is an independently-controllable pixel electrode of the type shown in FIG. 4B.

FIG. 2B illustrates an exemplary RBG color filter array pattern that can be used with a CFA-enabled color electrophoretic display. The dashed line defines a “pixel” for the purposes of defining a pixel in an image. Each pixel of the RGB CFA includes an independently controllable red, green, and blue partially-transmissive filter portion, known as a subpixel; a portion around each subpixel is clear (a.k.a., partial fill CFA) in order to improve white and light colors in an image, but with higher overall resolution that in FIG. 2A. Below each subpixel is an independently-controllable pixel electrode of the type shown in FIG. 4B.

FIG. 3 illustrates an exemplary method of evaluating the level of image sticking of a display. The electrophoretic displays are switched using a generic waveform to a white state and a black state. The lightness (L*) is measured at time=0. The displays are then switched to a black and white checkerboard with a generic waveform and placed into an 85 °C/22% RH (relative humidity) environmental chamber for 7 days. After 7 days of storage, the displays are taken out, cooled to room temperature, and switched to the black state and then the white state with a generic waveform. White state lightness (WS L*) of the squares in the checkerboard is measured for squares stored as white and black. Average values of WS L* are calculated for squares that were formerly white in the checkerboard and squares that were formerly black in the checkerboard. The level of image sticking is assessed using the difference in the averaged WS L* between the two types of regions.

FIG. 4A illustrates an exemplary equivalent circuit of a single pixel of an electrophoretic display that uses an active matrix backplane with a storage capacitor.

FIG. 4B illustrates an exemplary equivalent circuit of a simplified electrophoretic display of the invention, allowing driving in a row-column format.

FIG. 5 illustrates an exemplary electrophoretic display that includes a display module. The electrophoretic display also includes a processor, memory, one or more power supplies, and a controller. The electrophoretic display may also include sensors to allow the electrophoretic display to adjust operational parameters based upon the ambient environment, e.g., temperature and illumination.

FIG. 6 shows the image sticking analysis of displays formulated with different ink slurry dopant loadings.

### DETAILED DESCRIPTION OF THE INVENTION

Disclosed herein are electrophoretic displays and methods for preparing the same. The electrophoretic displays comprising the compositions described herein exhibit improved electric optical performances, such as reduced levels of image sticking and/or ghost images, after being stored at elevated temperatures. As a result, the display can achieve high-quality images without the need of regular refreshes.

### Electro-Optic Display

An electro-optic display, e.g., an electrophoretic display, may comprise a layer of an electro-optic medium and at least two other layers disposed on opposed sides of the electro-optic medium, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used in this patent and herein to mean that the layer thus designated transmits sufficient light to enable an observer, looking through that layer, to observe the change in display states of the electro-optic medium, which will normally be viewed through the light transmissive electrode layer and adjacent substrate (if present); in cases where the electro-optic medium displays a change in reflectivity at non-visible wavelengths, the term “light-transmissive” should of course be interpreted to refer to transmission of the relevant non-visible wavelengths.

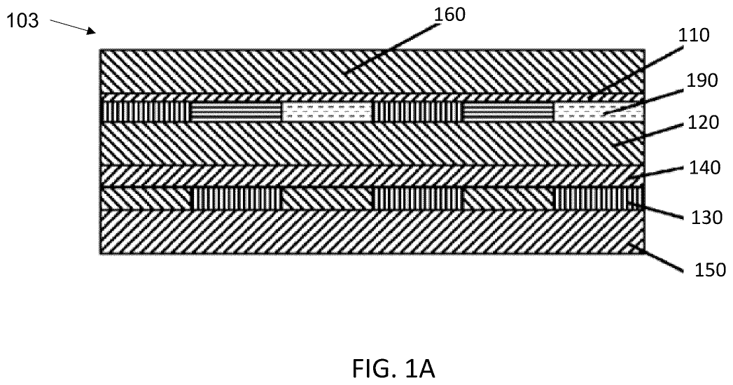

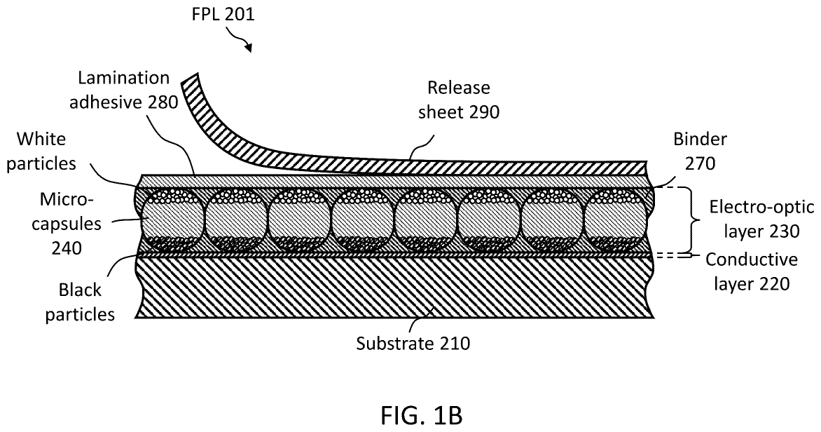

FIG. 1A illustrates an example of an electrophoretic display (103) comprising an encapsulated electrophoretic medium with black and white oppositely-charged particles. The display 103 includes a top transparent electrode 110, an electrophoretic medium layer 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. The display 103 also includes a color filter array (CFA) disposed between the electrophoretic layer and the viewer. The entire display stack may be disposed on a substrate 150, which may be rigid or flexible. The display may also include a protective layer 160, which may simply protect the top electrode 110 from damage, or it may envelop the entire display to prevent ingress of water, etc.

The manufacture of an electro-optic display normally involves at least one lamination operation. For example, manufacturing of an electrophoretic display may comprise coating an electrophoretic medium layer comprising capsules in a binder on to a flexible substrate comprising indium-tin-oxide (ITO) or a similar conductive coating (which acts as one electrode of the final display) on a plastic film, and drying the capsules/binder coating to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. In some embodiments, the backplane is flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

In some embodiments, a “slurry”, or an “ink slurry” of an electrophoretic medium layer is first prepared by mixing the capsules, binder, and additives (e.g., surfactant, rheology modifier). The slurry is then coated and assembled into an electrophoretic display.

U.S. Pat. No. 6,982,178 describes a method of assembling a solid electro-optic display (including an encapsulated electrophoretic display) which is well adapted for mass production. This patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially. Such films are available in bulk from various producers, such as Saint Gobain.

FIG. 1B depicts an example of an FPL, comprising a light-transmissive substrate 210, a light-transmissive electrode layer 220, an electro-optic layer 230, a lamination adhesive layer 280 and a release sheet 290; the release sheet is illustrated in the process of being removed from the lamination adhesive layer 280 preparatory to lamination of the FPL 201 to a backplane. The electro-optic layer 230 may be deposited on the conductive layer 220, typically by slot coating, the two layers being in electrical contact. The electro-optic layer 230 shown in FIG. 1B is a layer of encapsulated electrophoretic medium and comprises microcapsules 240, each of which comprises negatively charged white particles and positively charged black particles in a hydrocarbon-based fluid. The microcapsules 240 are held retained within a polymeric binder 270. Upon application of an electrical field across electro-optic layer 230, white particles move to the positive electrode and black particles move to the negative electrode, so that electro-optic layer 230 appears, to an observer viewing the display through substrate 210, white or black depending on whether conductive layer 220 is positive or negative relative to the adjacent pixel electrode in the backplane.

As an alternative to a “simple” FPL, as described above, U.S. Pat. No. 7,561,324 describes a so-called “double release sheet” which is a simplified version of the front plane laminate of U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate (FPL) already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

For example, U.S. Pat. No. 8,786,929 (incorporated by reference in its entirety) describes a self-supporting solid electro-optic medium, which can be prepared starting with a release sheet. A layer of the electro-optic medium is formed, by coating, printing or otherwise, on the release sheet, and thereafter an adhesive layer is formed over the electro-optic medium (i.e., on the opposed side of the electro-optic medium from the release sheet). The combined electro-optic medium and adhesive layer can then be used to apply the electro-optic medium to any desired substrate, which could be a three-dimensional object. If desired, a second layer of adhesive could be applied on the opposed side of the electro-optic medium from the layer first applied, thereby converting the electro-optic medium into a double-sided adhesive film which could be laminated, for example, to a backplane on one side and to a front substrate on the other. The use of a double release film allows the front substrate to be selected for properties such as color, water/oxygen barriers, ultra-violet filters, etc. The front substrate can be extremely thin. The final front substrate can alternatively be a stiff substrate, even glass or a glass color filter array.

In another alterative, the electro-optic displays, such as electrophoretic displays disclosed herein may be prepared from a “double release sheet” structure. The electrophoretic medium layer is first prepared on a release substrate and laminated to a front substrate (e.g., PET/ITO) using adhesive. The 3-layer stack can then be laminated to a backplane to form the display. In some embodiments, the electrophoretic display comprises a layer of adhesive between the electrophoretic medium layer and the top electrode. In some embodiments, the electrophoretic display comprises a layer of adhesive between the electrophoretic medium layer and the backplane electrode.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

The front plane laminate of the present invention is well adapted for mass production. For example, a roll of a commercial metallized plastic film may be converted to the front plane laminate by a roll-to-roll coating process using conventional commercial coating equipment. The metallized plastic film is first coated with a slurry of capsules in binder, as described in application Ser. No. 10/063,803 (now U.S. Pat. No. 6,822,782), and this capsule layer is dried. A layer of adhesive, for example the aforementioned aqueous urethane resin NeoRez R-9320, is then coated over the capsule layer and dried. The release sheet is then applied over the adhesive, and the combined front plane laminate can then be formed into rolls ready for storage and/or transportation. When it is desired to use the front plane laminate in the construction of displays, the laminate can be unrolled and cut into pieces of the size required for individual displays or groups of displays (in some cases, it may be convenient to laminate multiple displays in a single operation and then separate individual displays at a later stage) using conventional commercial apparatus.

The release sheet used in the front plane laminate of the present invention can be of any known type, provided of course that it does not contain materials which might adversely affect the properties of the electro-optic medium, and numerous suitable types of release sheet will be known to those skilled in the art. Typical release sheets comprise a substrate such as paper or a plastic film coated with a low surface energy material, for example a silicone.

Adhesive compositions for laminate structures are generally known. They are used to adhere together different layers of the laminate structure. Such adhesive compositions may comprise, for example, hot-melt type adhesives and/or wet-coat adhesives, such as polyurethane-based adhesives.

The performance of electro-optic displays, such as electrophoretic displays disclosed herein or prepared according to the methods disclosed herein may be evaluated using a variety of parameters. In some embodiments, the performance of the display may be evaluated by the level of image sticking or “ghost images” observed from the display. In some embodiments, the performance of the display may be evaluated by the contrast ratio (CR) of the display. In some embodiments, the performance of the display may be evaluated by the color gamut of the display. In some embodiments, the performance of the displays may be evaluated by the white state (WS) of the display. In some embodiments, the performance of the displays may be evaluated by the dark state (DS) L* of the display. In some embodiments, the performance of the display may be evaluated by the resolution of the display. In some embodiments, the performance of the display may be evaluated by image stability of the display. In some embodiments, the performance of the display may be evaluated by the amount of cloudy spot mura and/or panther mura observed. In some embodiments, the performance of the display may be evaluated by the amount of time it takes for the display to produce one or more independent colors. In some instances, two or more of the foregoing parameters may be evaluated. (“Mura” is a generalized term for defects in the sealing layer that results in sub-optimal optical states when viewed through a microscope. Cloudy spot mura looks like evaporated water spots under the microscope while panther mura appears as streaks.)

For the electro-optic displays described herein, color contamination should be minimized to the point that the colors formed are commensurate with an industry standard for color rendition. One of the standards is SNAP (the standard for newspaper advertising production), which specifies L*, a* and b* values for each of the eight primary colors (red, green, blue, cyan magenta, yellow, black and white) by using The CIELAB color system. Alternatively, a color space may be described using the CIE L*C*h system.

Image sticking and ghost images may be reduced by resetting the display, i.e., switching the display back and forth between black and white states. Image sticking or ghost images can be reduced, or in some cases eliminated, by resetting the display by regular resets of the display. However, storage at elevated temperatures and relative humidities for prolonged periods without resets may result in permanent image sticking. However, for certain applications, resetting the display may be undesirable or unacceptable for users. The selection of the appropriate amount of dopant can reduce or eliminate image sticking and ghost images when displays are stored for long periods without reset.

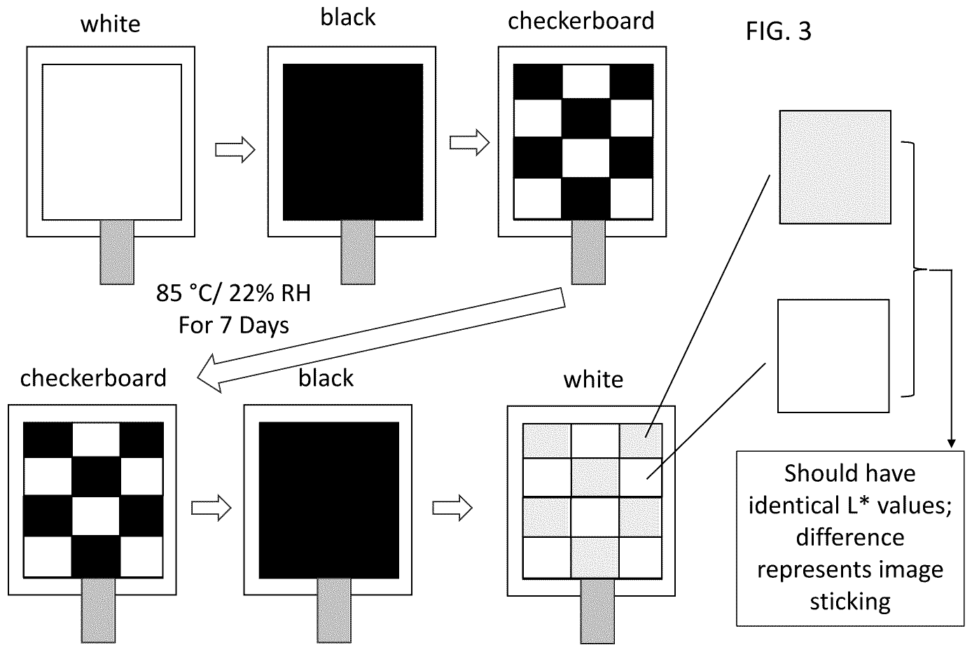

The amount of image sticking may be evaluated by a method such as described in FIG. 3. Displays are switched using a generic waveform between a white state and a black state. The lightness (L*) is measured at time equal 0. The displays are then switched to a black and white checkerboard, or test module, with a generic waveform and stored at a temperature and relative humidity for a period of time. For example, the display may be stored in environmental chamber at 85 °C and 22% RH (relative humidity) for 7 days. After the period of time, the displays are taken out, cooled to room temperature, and switched to white state with a generic waveform. White state lightness (WS L*) of the former white and black squares in the test module subjected to 85 °C and 22% RH for 7 days is measured. A “score” may be determined by averaging the difference of WS L* between the former white and the former black squares to assess the level of image sticking between the two types of regions. For electrophoretic displays with no image sticking, the difference in WS L* between the two types of regions is 0 L*. For severe image sticking, the average difference between the former black and the former white is −4.

In some embodiments, the electrophoretic display has a difference in WS L* of less than 2 L* for a white region and a black region of the same test module after being exposed to 85 °C and 22% RH for 7 days after 2 resets. In some embodiments, the electrophoretic display has a difference in WS L* of less than 1.5 L* for a white region and a black region of the same test module after being exposed to 85 °C and 22% RH for 7 days after 2 resets. In some embodiments, the electrophoretic display has a difference in WS L* of less than 1 L* for a white region and a black region of the same test module after being exposed to 85 °C and 22% RH for 7 days after 4 resets. In some embodiments, the electrophoretic display has a difference in WS L* of less than 0.75 L* for a white region and a black region of the same test module after being exposed to 85 °C and 22% RH for 7 days after 4 resets. In some embodiments, the electrophoretic display has a difference in WS L* of less than 0.75 L* for a white region and a black region of the same test module after being exposed to 85 °C and 22% RH for 7 days after 8 resets. In some embodiments, the electrophoretic display has a difference in WS L* of less than 0.5 L* for a white region and a black region of the same test module after being exposed to 85 °C and 22% RH for 7 days after 8 resets. In some embodiments, the electrophoretic display has a difference in WS L* of less than 0.75 L* for a white region and a black region of the same test module after being exposed to 85 °C. and 22% RH for 7 days after 10 resets. In some embodiments, the electrophoretic display has a difference in WS L* of less than 0.5 L* for a white region and a black region of the same test module after being exposed to 85 °C and 22% RH for 7 days after 10 resets.

One aspect of the present disclosure provides an electrophoretic display comprising: a light-transmissive top electrode; an electrophoretic medium layer comprising a continuous phase and a discontinuous phase; and a backplane electrode, wherein the discontinuous phase comprises a plurality of capsules encapsulating an electrophoretic medium and the continuous phase surrounds the discontinuous phase and comprises a binder, a surfactant, a viscosity modifier, a solvent, and a dopant; wherein the dry mass weight ratio of capsule to dopant is at least 2000:1; and wherein the electrophoretic display has a difference in white state (WS) L* of less than 2 L* after 2 resets for a white region and a black region of a test module after being exposed to 85 °C and 22% relative humidity for 7 days.

Another aspect of the present disclosure provides a method for preparing an electrophoretic display comprising: forming an electrophoretic medium layer comprising a continuous phase and a discontinuous phase; contacting a first layer of adhesive with the electrophoretic medium layer; contacting a second layer of adhesive with the opposed side of the electrophoretic medium layer from the previously coated layer of adhesive; and contacting one of the adhesive layers with a light-transmissive top electrode and the other adhesive layer with a backplane electrode; wherein the discontinuous phase comprises a plurality of capsules and the continuous phase surrounds the discontinuous phase and comprises a binder, a surfactant, a viscosity modifier, a solvent, and a dopant; and wherein the dry mass weight ratio of capsule to dopant is at least 2000:1. In some embodiments, the method further comprises applying a layer of color filter on the layer of electrophoretic medium.

In some embodiments, the electrophoretic display described herein or prepared according to the method described herein further comprises at least one layer of adhesive. In some embodiments, the electrophoretic display described herein or prepared according to the method described herein comprises a layer of adhesive may be between the electrophoretic medium layer and the top electrode. In some embodiments, the electrophoretic display described herein or prepared according to the method described herein comprises a layer of adhesive between the electrophoretic medium layer and the backplane electrode. In some embodiments, the electrophoretic display described herein or prepared according to the method described herein further comprises a color filter layer.

### Electro-Optic Medium

As illustrated in FIG. 1B, the electro-optic layer, which may be referred to as an electrophoretic medium layer, comprises a continuous phase and a discontinuous phase. The discontinuous phase comprises a plurality of capsules encapsulating an electrophoretic medium. Specifically, each capsule may be filled with a suspending fluid comprising at least one particle dispersed in a solvent and capable of moving through the fluid upon application of an electric field to the electro-optic medium. The continuous phase surrounds and encapsulates the discontinuous phase, thus providing a cohesive electrophoretic medium.

The solvent within the capsules may be of low dielectric constant (e.g., less than 10 or less than 3). In some embodiments, the solvent comprises a hydrocarbon solvent, such as heptane, octane, and petroleum distillates such as Isopar (Exxon Mobil) or Isane® (Total); terpenes such as limonene, e.g., 1-limonene; and/or aromatic hydrocarbons such as toluene. The index of refraction of the internal phase of a capsule may be modified with the addition of index matching agents such as Cargille® index matching fluids available from Cargille-Sacher Laboratories Inc. (Cedar Grove, N.J.).

The charged particles may vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. The electrophoretic medium may comprise pigments having white, black, cyan, magenta, yellow, blue, green, red, and other colors.

The pigment particle loading amount in the suspending fluid may vary. In some embodiments, the suspending fluid may have a total charged pigment particle loading of at least 20%, at least 30%, at least 35%, at least 40%, at least 45%, at least 50%, at least 60%, or at least 70%.

The electrophoretic medium may contain two types of charged particles having different colors, a first type of charged particles having a first charge polarity, and a second type of charged particles that have a second charged polarity opposite to the first charged polarity. For example, the first type of charged particles may be black and the second type of charged particles may be white.

In some embodiments, the electrophoretic medium comprises two different kinds of charged pigment particles dispersed in a hydrocarbon solvent, a first type of charged particles having a first charge polarity, and a second type of charged particles that has a second charged polarity opposite to the first charged polarity. In some embodiments, the two kinds of pigment particles are black and white.

The electrophoretic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. For example, the first type of charged particles may be black, the second type of charged particles may be white, and the third type of charged particles may be selected from the group consisting of red, yellow, blue, cyan, magenta, green, and orange.

The electrophoretic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may be higher than the charge of the fourth type of particles. For example, the first type of charged particles may be cyan, the second type of charged particles may be magenta, the third type of particles may be yellow and the fourth type of charged particles may be white.

The electrophoretic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. For example, the first type of particles may be cyan, the second type of particles may be magenta, the third type of particles may be yellow, and the fourth type of particles may be white.

The electrophoretic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. For one example, the first type of particles may be cyan, the second type of particles may be magenta, the third type of particles may be black, the fourth type of particles may be yellow, and the fifth type of particles may be white.

In some embodiments, color electrophoretic displays can also be achieved using color filters arrays (CFA) disposed above or below a layer of electrophoretic display materials, for example a layer of microcapsules with black and white oppositely-charged particles that change position relative to a viewer due to a provided electric field. See, e.g., U.S. Pat. Nos. 8,098,418 and 10,444,592, the contents of which are incorporated by reference in their entireties. Methods for forming color filter elements on display materials are descried in U.S. Pat. No. 10,209,556, which is incorporated by reference in its entirety.

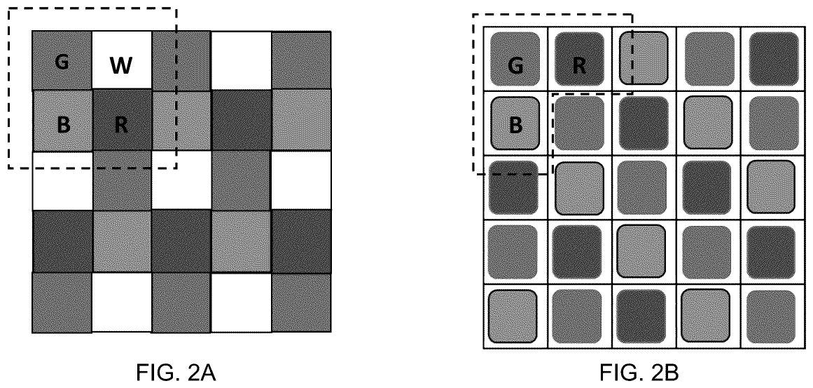

FIG. 2A is an exemplary RBGW color filter array pattern that can be incorporated in a CFA display 103. The colored elements may be provided directly on the top transparent electrode 110, which may be, for example, indium-tin-oxide (ITO). Such CFA films are available from Toppan Printing (Japan). Alternatively, the color filter elements may be applied to the electrophoretic medium layer 120 with an ink-jet or other precision printing process. See U.S. Pat. No. 10,209,556. As shown in FIGS. 2A and 2B, the dashed line defines a “pixel” for the purposes of defining a pixel in an image. In FIG. 2A, each pixel of the RGBW CFA includes independently-controllable red, green, and blue subpixels and an equally-sized clear (a.k.a. white) subpixel to improve white and lighter colors in an image. In FIG. 2B, each pixel of the RGB CFA includes independently-controllable red, green, and blue subpixel with a portion around each subpixel being clear (a.k.a., partial fill CFA) in order to improve white and light colors in an image. In practice CFA patterns of FIG. 2B are preferred over the patterns of FIG. 2A because each image pixel is slightly smaller and thus a higher resolution can be achieved for the same number of pixel electrodes per inch (PPI), typically between 100 and 400 PPI, more commonly between 150 and 300 PPI.

In addition, the charged pigment particles may be functionalized with surface polymers to improve state stability. Such pigments are described in U.S. Patent Publication No. 2016/0085132, which is incorporated by reference in its entirety.

Encapsulation of the internal phase of the capsules may be accomplished in a number of different ways. Numerous suitable procedures for microencapsulation are detailed in both Microencapsulation, Processes and Applications, (I. E. Vandegaer, ed.), Plenum Press, New York, N.Y. (1974) and Gutcho, Microcapsules and Mircroencapsulation Techniques, Nuyes Data Corp., Park Ridge, N.J. (1976), both of which are hereby incorporated by reference herein. The processes fall into several general categories, all of which can be applied to the present invention: interfacial polymerization, in situ polymerization, physical processes, such as coextrusion and other phase separation processes, in-liquid curing, and simple/complex coacervation.

Numerous materials and processes may prove useful in formulating displays of the present invention. Useful materials for simple coacervation processes include, but are not limited to, gelatin, polyvinyl alcohol, polyvinyl acetate, and cellulosic derivatives, such as, for example, carboxymethylcellulose. Useful materials for complex coacervation processes include, but are not limited to, gelatin, acacia, carageenan, carboxymethylcellulose, hydrolized styrene anhydride copolymers, agar, alginate, casein, albumin, methyl vinyl ether co-maleic anhydride, and cellulose phthalate. Useful materials for phase separation processes include, but are not limited to, polystyrene, PMMA, polyethyl methacrylate, polybutyl methacrylate, ethyl cellulose, polyvinyl pyridine, and poly acrylonitrile. Useful materials for in situ polymerization processes include, but are not limited to, polyhydroxyamides, with aldehydes, melamine, or urea and formaldehyde; water-soluble oligomers of the condensate of melamine, or urea and formaldehyde; and vinyl monomers, such as, for example, styrene, MMA and acrylonitrile. Finally, useful materials for interfacial polymerization processes include, but are not limited to, diacyl chlorides, such as, for example, sebacoyl, adipoyl, and di- or poly-amines or alcohols, and isocyanates. Useful emulsion polymerization materials may include, but are not limited to, styrene, vinyl acetate, acrylic acid, butyl acrylate, t-butyl acrylate, methyl methacrylate, and butyl methacrylate.

In some embodiments, the capsules may comprise gelatin-based capsule walls. The gelatin is available from various commercial suppliers, such as Sigma Aldrich or Gelitia USA. It can be obtained in a variety of grades and purity depending upon the needs of the application. Gelatin primarily comprises collagen that has been collected from animal products (cow, pig, poultry, fish) and hydrolyzed. It comprises a mixture of peptides and proteins. In some embodiments, the gelatin is combined with acacia (gum arabic), which is derived from the hardened sap of the acacia tree. Acacia is a complex mixture of glycoproteins and polysaccharides, and it is often used as a stabilizer in food stuffs. Aqueous solutions of acacia and gelatin can be coacervated with a non-polar internal phase to produce clear and flexible capsules containing internal phase.

The electrophoretic medium layer of the present invention may contain any of the additives used in prior art electrophoretic medium layer as described for example in the E Ink and MIT patents and applications mentioned above. Thus, for example, the electrophoretic media of the present invention may comprise a charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

In some embodiments, the electrophoretic medium layer comprises a surfactant. Surfactants have been used for some time with electrophoretic media to improve the performance of the media. The surfactant may be of any type, such as an anionic surfactant, a cationic surfactant, a nonionic surfactant, an amphoteric surfactant, a zwitterionic surfactant, or a combination thereof. Surfactants tend to lower the surface tension between two liquids (interfacial tension). The surfactant may contain both one or more hydrophobic functional groups and one or more hydrophilic functional groups. In some embodiments, the electrophoretic medium layer comprises a nonionic surfactant, such as TritonX100.

In some embodiments, the electrophoretic medium layer comprises a rheology modifier. Rheology modifiers are compounds, typically polymeric materials, which adjust the rheology, such as viscosity, of the medium to the desired value. In some embodiment, the rheology modifier comprises a viscosity modifier. In some embodiment, the viscosity modifier comprises hydroxypropyl methyl cellulose (HPMC).

In some embodiments, the electrophoretic medium layer comprises a dopant, for example, (a) a salt, a polyelectrolyte, a polymer electrolyte, a solid electrolyte, and combinations thereof; or (b) a non-reactive solvent, a conductive organic compound, or combinations thereof. In one form, the additive may be a salt such as an inorganic salt, organic salt, or combination thereof, as described in U.S. Pat. No. 7,012,735, incorporated by reference in its entirety.

In some embodiments, the dopant may comprise a salt having anions containing at least three fluorine atoms as described in U.S. Pat. No. 8,446,664, incorporated by reference in its entirety. The salt may, for example, have a hexafluorophosphate anion. The salt may also have an imidazolium cation and/or an anion. Exemplary salts include 3-butyl-1-methylimidazolium hexafluorophosphate (hereinafter “BMIPF6” 1-butyl-3-methylpiperidinium hexafluorophosphate, 1-butyl-3-methylpyridinium hexafluorophosphate, 1-ethyl-3-methylimidazolium hexafluorophosphate, sodium hexafluorophosphate, 1-butyl-3-methylimidazolium trifluoromethanesulfonate and 1-butyl-3-methylimidazolium boron tetrafluoride. In some embodiments, the dopant comprises 1-butyl-3-methylimidazolium hexafluorophosphate.

The amount of dopant in the electrophoretic medium layer may vary. In some embodiments, the dry mass weight ratio of capsule to dopant may be at least at least 2000:1, at least 2500:1, at least 3000:1, at least 3500:1, at least 4000:1, at least 4500:1, or at least 5000:1. In some embodiments, the dry mass weight ratio of capsule to dopant may range from 2000:1 to 5000:1, from 2000:1 to 4500:1, from 2000:1 to 4000:1, from 2000:1 to 3500:1, from 2000:1 to 3000:1, from 2500:1 to 5000:1, from 2500:1 to 4500:1, from 2500:1 to 4000:1, from 2500:1 to 3500:1, from 2500:1 to 3000:1. In some embodiments, the dry mass weight ratio of capsule to dopant is about 2000:1. In some embodiments, the dry mass weight ratio of capsule to dopant is about 2500:1. In some embodiments, the dry mass weight ratio of capsule to dopant is about 3000:1. In some embodiments, the dry mass weight ratio of capsule to dopant is between 2000:1 to 5000:1. In some embodiments, the dry mass weight ratio of capsule to dopant is between 2000:1 to 3000:1. The “dry mass weight ratio” disclosed herein is calculated using the dry mass weight of the total amount of the capsules and the total amount of the dopant in the display layer. In some embodiments, desirable electric optical performances, such as reduced levels of image retention (e.g., image sticking, “ghost” images) can be achieved with a preferred range of dopants in the binder that holds together a layer of electrophoretic medium. The electrophoretic medium layer disclosed herein may be incorporated into electrophoretic displays and assemblies disclosed herein, or may be adopted in methods for preparing electrophoretic displays disclosed herein.

### Driving the Device

For the most part, electrophoretic media, such as described above, are designed to be driven with low voltage square waves, such as produced by a driver circuit using a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts” or “image sticking”.

The term impulse, when used to refer to driving an electrophoretic display, is used herein to refer to the integral of the applied voltage with respect to time during the period in which the display is driven. The term waveform, when used to refer to driving an electrophoretic display is used to describe a series or pattern of voltages provided to an electrophoretic medium over a given time period (seconds, frames, etc.) to produce a desired optical effect in the electrophoretic medium.

Waveforms for driving four-particle electrophoretic media have been described previously. Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active matrix backplanes (260) because of the wider availability of fabrication facilities and the costs of the various starting materials. Amorphous silicon thin-film transistors may become unstable when supplied gate voltages that would allow switching of voltages higher than about +/−15V, e.g., +/−24V or +/−30V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active matrix backplanes (260), including IGZO, i.e., as described in U.S. Pat. No. 11,776,496, which is incorporated by reference in its entirety.

In some embodiments, the electrophoretic display may include only a first light-transmissive electrode, an electrophoretic medium, and a second (rear) electrode, which may also be light-transmissive. However, to produce a high-resolution display, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer framewidths are possible.

In a conventional electrophoretic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

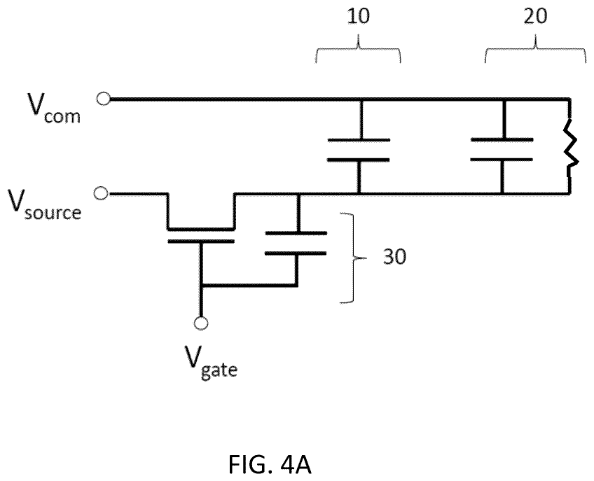

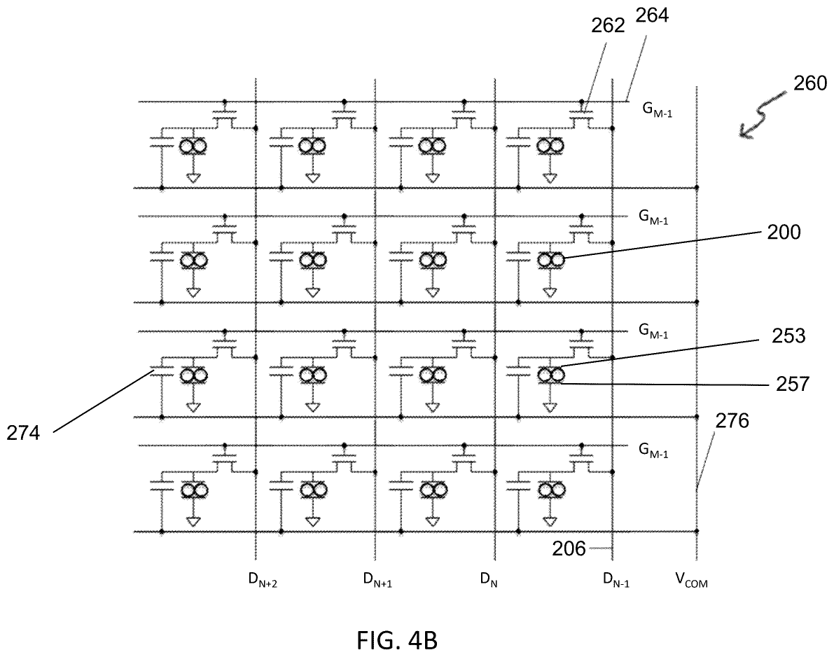

FIG. 4A depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 260 for image driving, as shown in FIG. 4B. For example, each pixel electrode 253 (corresponding to 130 in FIG. 1A) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIG. 1A) has the form of a single continuous electrode while the other electrode or electrode layer is patterned into a matrix of pixel electrodes 253, each of which defines one pixel of the display.

Between the pixel electrode 253 and the common electrode 257, an electrophoretic medium 200 can be disposed. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. Each pixel of the active matrix 260 also includes a storage capacitor 274 as discussed above with respect to FIG. 4A. The storage capacitors 274 may be coupled to a common potential (Vcom) line 276. In some embodiments, the common light-transparent electrode 257 is coupled to ground, as shown in FIG. 4B. In some embodiments, the common light-transparent electrode 257 is also coupled to Vcom line 276 (not shown in FIG. 4B).

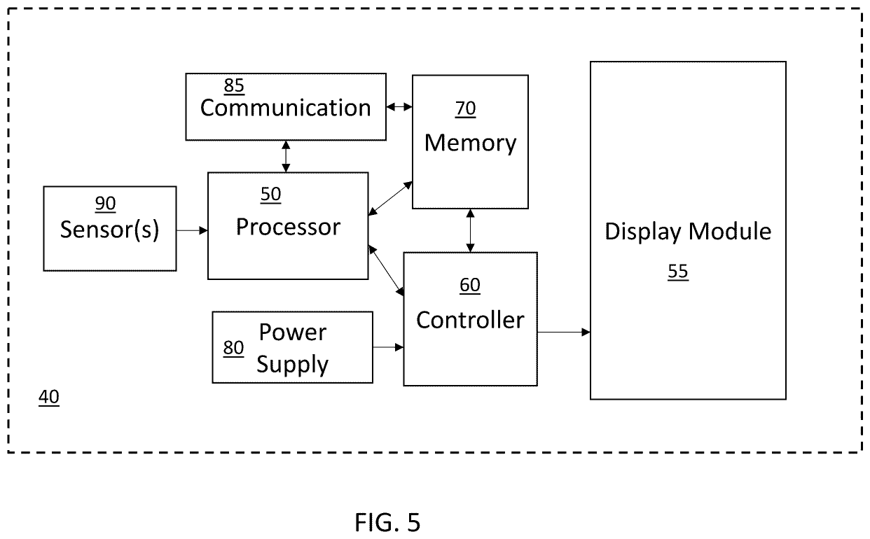

The active matrix 260 described with respect to FIG. 4B (i.e., including the electrophoretic medium 200 and the common light-transparent electrode 257) is typically covered by a protective sheet (e.g., integrated barrier) and sealed to create a display module 55, as shown in FIG. 5. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electro-optic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Disclosed herein are electrophoretic medium layer compositions comprising a dopant. Slurries comprising capsules, TritonX100 surfactant, polyurethane binder, HPMC viscosity modifier, butanol, and BMIPF6 dopant were coated on an ink release substrate, dried, and subsequently laminated to adhesives coated on PET/ITO and release to form a 3-layer electrophoretic ink stack. These stacks were then laminated to test glass reference structure and a protective sheet barrier was laminated to provide moisture/UV barrier to the electrophoretic display. TritonX100, binder, HMPC, and butanol were added at fixed ratios while the amount of BMIPF6 was varied among different compositions.

The electrophoretic displays were switched using a generic waveform to a white state and then a black state and the lightness was measured at time=0. The displays were then switched to a black and white checkerboard, again with a generic waveform, and placed into an 85 °C/22% RH (relative humidity) environmental chamber for 7 days. After 7 days of storage, the displays were taken out, allowed to cool to room temperature, and switched to the black state and then the white state with a generic waveform. Lightness of the white state (WS L*) was measured for both white squares and black squares stored at 85 °C/22% R. See FIG. 3. The level of image sticking was calculated as a difference in white state lightness of a pixel stored in black state and a pixel stored in white state. This image sticking score was calculated for various clearing switches. See FIG. 3.

A formulation experiment was carried out at the pilot scale to evaluate the severity of image sticking as a function of varying levels of ink slurry dopant. The dopant loadings in Table 1 are represented as a ratio to the capsules; thus a smaller number represents higher loadings of the dopant in the ink system.

TABLE 1
Dopant loading in formulations A-E.

| Slurry Formulation | Capsule to BMIPF6 Dopant Ratio |
|---|---|
| A | 1000 |
| B | 500 |
| C | 2000 |
| D | 2500 |
| E | 3000 |

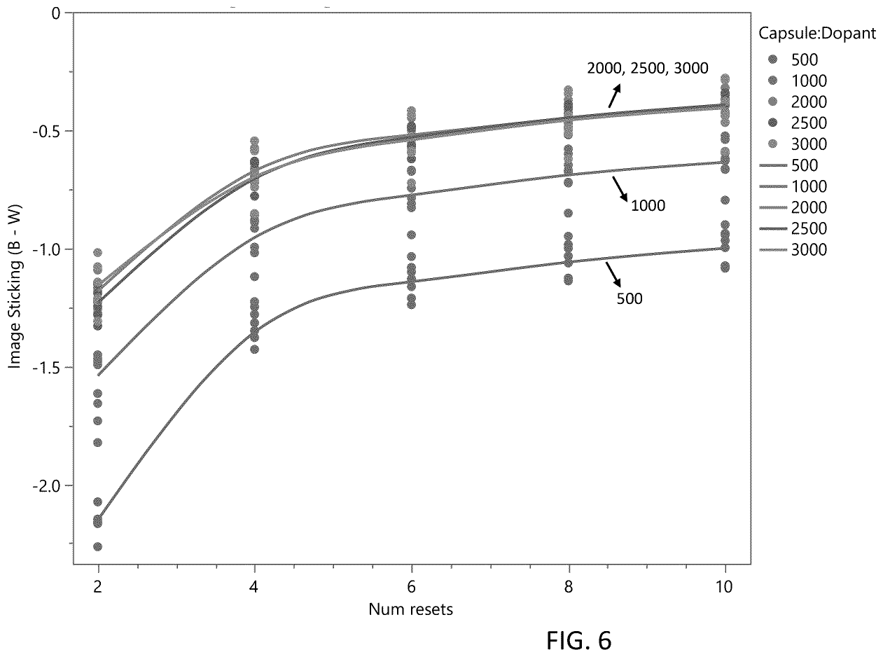

FIG. 6 shows that image sticking improves with reduced slurry dopant loading. Conversely, more dopant in the slurry worsens image sticking. Ink slurry dopant in the range of 2000-3000 (as a ratio of the amount of capsules to the amount of dopant) gives similar image sticking performance. In summary, image sticking is improved with reduced slurry dopant loading.

What is claimed is:

1. An electrophoretic display comprising:
a light-transmissive top electrode;
an electrophoretic medium layer comprising a continuous phase and a discontinuous phase; and
a backplane electrode;
wherein the discontinuous phase comprises a plurality of capsules encapsulating an electrophoretic medium and the continuous phase surrounds the discontinuous phase and comprises a binder, a surfactant, a viscosity modifier, a solvent, and a dopant;
wherein the dry mass weight ratio of capsule to dopant is at least 2000:1; and
wherein the electrophoretic display has a difference in white state (WS) L* of less than 2 L* after 2 resets for a white region and a black region of a test module after being exposed to 85 °C and 22% relative humidity for 7 days.

2. The electrophoretic display of claim 1, wherein the electrophoretic display has a difference in WS L* of less than 1.5 L* after 2 resets for the white region and the black region of the test module after being exposed to 85 °C and 22% relative humidity for 7 days.

3. The electrophoretic display of claim 1, wherein the dopant comprises an imidazolium cation and/or an anion containing at least three fluorine atoms.

4. The electrophoretic display of claim 3, wherein the dopant comprises 1-butyl-3-methylimidazolium hexafluorophosphate.

5. The electrophoretic display of claim 1, wherein the dry mass weight ratio of capsule to dopant is between 2000:1 to 5000:1.

6. The electrophoretic display of claim 5, wherein the dopant comprises an imidazolium cation and/or an anion containing at least three fluorine atoms.

7. The electrophoretic display of claim 6, wherein the dopant comprises 1-butyl-3-methylimidazolium hexafluorophosphate.

8. The electrophoretic display of claim 5, wherein the dry mass weight ratio of capsule to dopant is between 2000:1 to 3000:1.

9. The electrophoretic display of claim 1, wherein the electrophoretic medium comprises two different kinds of charged pigment particles dispersed in a hydrocarbon solvent.

10. The electrophoretic display of claim 9, wherein the two kinds of pigment particles are black pigment particles and white pigment particles.

11. The electrophoretic display of claim 1 further comprising at least one layer of adhesive.

12. The electrophoretic display of claim 11, comprising a layer of adhesive between the electrophoretic medium layer and the top electrode, a layer of adhesive between the electrophoretic medium layer and the backplane electrode, or a combination thereof.

13. The electrophoretic display of claim 1, further comprising a color filter layer.

14. A method for preparing an electrophoretic display comprising:
forming an electrophoretic medium layer comprising a continuous phase and a discontinuous phase;
contacting a first layer of adhesive with the electrophoretic medium layer;
contacting a second layer of adhesive with the opposed side of the electrophoretic medium layer from the previously coated layer of adhesive; and
contacting one of the adhesive layers with a light-transmissive top electrode and the other adhesive layer with a backplane electrode;
wherein the discontinuous phase comprises a plurality of capsules and the continuous phase surrounds the discontinuous phase and comprises a binder, a surfactant, a viscosity modifier, a solvent, and a dopant; and
wherein the dry mass weight ratio of capsule to dopant is at least 2000:1.

15. The method of claim 14, wherein the dopant comprises an imidazolium cation and/or an anion containing at least three fluorine atoms.

16. The method of claim 15, wherein the dopant comprises 1-butyl-3-methylimidazolium hexafluorophosphate (BMIPF6).

17. The method of claim 14, wherein the dry mass weight ratio of capsule to dopant is between 2000:1 to 5000:1.

18. The method of claim 17, wherein the dry mass weight ratio of capsule to dopant is between 2000:1 to 3000:1.

19. The method of claim 14, wherein the electrophoretic medium comprises two different kinds of charged pigment particles dispersed in a hydrocarbon solvent.

20. The method of claim 14, further comprising applying a layer of color filter on the layer of electrophoretic medium.
